(19) United States
(12) Patent Application Publication
(10) Pub. No.: US 2024/0000146 A1
(43) Pub. Date: Jan. 4, 2024

(54) VAPORIZATION CORE FOR E-CIGARETTE, CARTRIDGE FOR E-CIGARETTE, AND E-CIGARETTE

(71) Applicant: BYD PRECISION MANUFACTURE CO., LTD., Shenzhen (CN)

(72) Inventors: Qibin JIN, Shenzhen (CN); Chaonan CHEN, Shenzhen (CN); Yinbo LU, Shenzhen (CN)

(21) Appl. No.: 18/344,881

(22) Filed: Jun. 30, 2023

(30) Foreign Application Priority Data
Jul. 4, 2022 (CN) 202221722190.4

(51) Int. Cl. A24F 40/44; A24F 40/10; A24F 40/46; A24F 40/42

(52) U.S. Cl. CPC A24F 40/44; A24F 40/10; H05B 3/0014; A24F 40/42; A24F 40/46

(57) ABSTRACT

Provided are a vaporization core for an e-cigarette, a cartridge for an e-cigarette, and an e-cigarette. The vaporization core includes: a liquid guide body, where the liquid guide body has a first side surface and a second side surface arranged opposite to each other, at least a part of the first side surface forms a liquid absorbing region, at least a part of the second side surface forms a vaporization region, the liquid guide body includes a liquid guide portion, the liquid guide portion is a part of the liquid guide body between the first side surface and a position obtained by translating the first side surface to the second side surface by 1 mm to 4 mm, a liquid storage amount Q2 of the liquid guide portion is equal to 2.5 mg to 75 mg; and a heating body arranged at the vaporization region of the second side surface.

### CROSS-REFERENCE TO RELATED APPLICATION

This application claims priority to Chinese Patent Application No. 202221722190.4, filed with the China National Intellectual Property Administration on Jul. 4, 2022, and entitled “VAPORIZATION CORE FOR E-CIGARETTE, CARTRIDGE FOR E-CIGARETTE, AND E-CIGARETTE”, the entire contents of which are incorporated herein by reference.

### FIELD

The present disclosure relates to the field of e-cigarette technologies, and more specifically, to a vaporization core for an e-cigarette, a cartridge for an e-cigarette, and an e-cigarette.

### BACKGROUND

As the control and restrictions on tobacco become more stringent around the world, e-cigarettes, as a substitute for conventional tobacco, can not only simulate the sensory experience of smoking, but also cause far less damage to health than the conventional tobacco, which makes the demand for e-cigarettes increase year by year.

The e-cigarette usually includes a cartridge and a cigarette rod. The cartridge is mounted on the cigarette rod and can produce smoke to be inhaled by the human body. The cartridge has an e-liquid storage cavity, an airway, a vaporization cavity, and a vaporization core. A vaporization liquid for generating smoke is provided inside the e-liquid storage cavity. The vaporization liquid is heated and vaporized by the vaporization core to form smoke, and the smoke enters the vaporization cavity, and then enters the airway through the vaporization cavity and is inhaled by the user.

In the related art, when users inhale e-cigarettes, phenomena such as “e-liquid frying” or “burnt core” often occur, which seriously affect the taste of the smoke.

### SUMMARY

The present disclosure is intended to resolve at least one of the technical problems in the related art. Therefore, embodiments of the present disclosure are to provide a vaporization core for an e-cigarette. The vaporization core is assembled in the e-cigarette. During inhalation of a user, a vaporization liquid can be fully vaporized, which reduces the phenomenon of “e-liquid frying” in the e-cigarette, and can avoid the phenomenon of “burnt core” during inhalation of the user, making the taste of the smoke purer.

The present disclosure further provides a cartridge for an e-cigarette having the foregoing vaporization core for the e-cigarette.

The present disclosure further provides an e-cigarette having the foregoing cartridge for an e-cigarette.

According to an embodiment in a first aspect of the present disclosure, a vaporization core for an e-cigarette is provided, including: a liquid guide body, the liquid guide body having a first side surface and a second side surface arranged opposite to each other, at least a part of the first side surface forming a liquid absorbing region, at least a part of the second side surface forming a vaporization region, the liquid guide body including a liquid guide portion, the liquid guide portion being a part of the liquid guide body between the first side surface and a position obtained by translating the first side surface to the second side surface by 1 mm to 4 mm, a liquid storage amount Q2 of the liquid guide portion being equal to 2.5 mg to 75 mg; and a heating body arranged at the vaporization region of the second side surface.

It has been found in the research process that, the reason for the phenomenon of “e-liquid frying” or burnt core that occurs during inhalation of the e-cigarette in the related art is that: after the vaporization liquid in the liquid storage cavity of the e-cigarette enters the vaporization core, a part of the vaporization liquid cannot be fully vaporized, and gathers in a non-vaporization region of the vaporization core, and the non-vaporization region of the vaporization core will also be heated by the heating body, but it is insufficient to vaporize the e-liquid, resulting in “e-liquid frying”. During inhalation of the user, this part of the vaporization liquid will be inhaled into the user's mouth along with the smoke, which seriously affects the taste of the smoke. In the related art, there is also a phenomenon that the vaporization liquid transmitted to the vaporization region is insufficient, resulting in “burnt core”, which will also seriously affect the taste of the smoke.

It has been further found through research that a temperature of a part of the liquid guide body between the first side surface and a position obtained by translating the first side surface to the second side surface by 1 mm to 4 mm cannot reach a vaporization temperature of the vaporization liquid. This part is a non-vaporization region, and this part of non-vaporization region of the liquid guide body is defined as the liquid guide portion, and other parts are defined as a liquid storage portion. By controlling the liquid storage amount of the liquid guide portion, the liquid storage amount Q2 of the liquid guide portion of the liquid guide body is equal to 2.5 mg to 75 mg, which can reach a balance with the amount of vaporization liquid vaporized by the vaporization core in one inhalation cycle, so that problems such as “e-liquid frying” or “burnt core” during inhalation of the e-cigarette in the related art that seriously affect the inhalation taste of the e-cigarette can be effectively solved.

According to some embodiments of the present disclosure, the liquid storage amount Q1 of the liquid storage portion satisfies: Q1=a volume of the liquid storage portion×porosity of the liquid storage portion×a density of the vaporization liquid.

According to some embodiments of the present disclosure, quality of the vaporization liquid actually vaporized by the vaporization core in one inhalation cycle is defined as a single-inhalation vaporization amount T1; and a liquid guide amount D1 of the liquid guide portion meets: 0.5T1≤D1≤1.2T1.

According to some embodiments of the present disclosure, the liquid guide amount D1 of the liquid guide portion meets: 0.8T1≤D1≤1.0T1.

According to some embodiments of the present disclosure, a liquid guide amount D1 of the liquid guide portion ranges from 2.5 mg to 12 mg.

According to some embodiments of the present disclosure, in one inhalation cycle, an inhalation time of the vaporization core is 2.9 seconds to 3.1 seconds, and a total inhalation flow of the vaporization core is 54.4 ml to 55.6 ml.

According to some embodiments of the present disclosure, the single-inhalation vaporization amount T1 is equal to 5 mg to 10 mg.

According to some embodiments of the present disclosure, a liquid guide amount D1 of the liquid guide portion and the liquid storage amount Q2 of the liquid guide portion meet: D1≤Q2≤3D1.

According to some embodiments of the present disclosure, the liquid storage amount Q2 of the liquid guide portion satisfies: Q2=the volume of the liquid guide portion×the porosity of the liquid guide portion×the density of a vaporization liquid.

According to some embodiments of the present disclosure, the liquid guide body further includes a liquid storage portion, and the liquid storage portion is a part of the liquid guide body between the second side surface and a position obtained by translating the first side surface to the second side surface by 1 mm to 4 mm; and the liquid guide portion and the liquid storage portion are separate pieces or an integral piece.

According to some embodiments of the present disclosure, the liquid guide body further includes a liquid storage portion, and the liquid storage portion is a part of the liquid guide body between the second side surface and a position obtained by translating the first side surface to the second side surface by 1 mm to 4 mm; and materials of the liquid guide portion and the liquid storage portion are the same or different.

According to some embodiments of the present disclosure, the liquid guide portion is ceramic or e-liquid absorbing cotton; and the liquid storage portion is ceramic or e-liquid absorbing cotton.

According to some embodiments of the present disclosure, the liquid guide portion is formed by one or more porous ceramic members; the liquid guide portion is formed by one or more pieces of e-liquid absorbing cotton; or the liquid guide portion is jointly formed by one or more porous ceramic members and one or more pieces of e-liquid absorbing cotton.

According to some embodiments of the present disclosure, the liquid storage portion is formed by one or more porous ceramic members; the liquid storage portion is formed by one or more pieces of e-liquid absorbing cotton; or the liquid storage portion is jointly formed by one or more porous ceramic members and one or more pieces of e-liquid absorbing cotton.

According to some embodiments of the present disclosure, the heating body is a heating circuit printed on the vaporization region of the second side surface; or the heating body is a heating metal mesh arranged at the vaporization region of the second side surface.

According to some embodiments of the present disclosure, the liquid guide body further includes a liquid storage portion, and the liquid storage portion is a part of the liquid guide body between the second side surface and a position obtained by translating the first side surface to the second side surface by 1 mm to 4 mm; and an orthographic projection area of the liquid guide portion is less than or equal to an orthographic projection area of the liquid storage portion within a plane perpendicular to a direction from the first side surface to the second side surface.

According to some embodiments of the present disclosure, the liquid storage portion is constructed as a cuboid shape; and the liquid guide portion is constructed as a cuboid shape, a frustum of trapezoidal prism shape, or a frustum of triangular prism shape.

According to some embodiments of the present disclosure, an area of the liquid absorbing region is less than or equal to an area of the vaporization region.

According to some embodiments of the present disclosure, the first side surface is constructed as a flat surface, a polyline curved surface, an arc curved surface, or a spherical surface; and the second side surface is constructed as a flat surface, a polyline curved surface, an arc curved surface, or a spherical surface.

According to some embodiments of the present disclosure, the vaporization core for the e-cigarette further includes: a vaporization core seal member, where the vaporization core seal member is sleeved on the liquid guide body, the vaporization core seal member has a liquid flowing opening, and the at least part of the first side surface is exposed from the liquid flowing opening to form the liquid absorbing region.

According to an embodiment in a second aspect of the present disclosure, a cartridge for an e-cigarette is provided, including: a housing having a liquid storage cavity, an airway, and a vaporization cavity, in which the vaporization cavity is in communication with the airway, and the housing has an air inlet in communication with the vaporization cavity and an air outlet in communication with the airway; and the vaporization core for the e-cigarette according to the embodiment in the first aspect of the present disclosure, where the vaporization core is arranged inside the housing, the liquid absorbing region of the first side surface is in communication with the liquid storage cavity, and the vaporization region of the second side surface is in communication with the vaporization cavity.

The cartridge for the e-cigarette according to the embodiment in the second aspect of the present disclosure uses the vaporization core for the e-cigarette according to the embodiment in the first aspect of the present disclosure, which can match the single-inhalation vaporization amount, thereby ensuring the amount of vapor output, and ensuring that the vaporization liquid is fully vaporized.

According to an embodiment in a third aspect of the present disclosure, an e-cigarette is provided, including: the cartridge according to the embodiment in the second aspect of the present disclosure; a cigarette rod having an electrical component arranged therein, in which the electrical component is electrically connected to the heating body, and the electrical component is configured to supply power to the heating body.

The e-cigarette according to the embodiment in the third aspect of the present disclosure uses the cartridge according to the embodiment in the second aspect of the present disclosure, which can match the single-inhalation vaporization amount, thereby ensuring the amount of vapor output, and ensuring that the vaporization liquid is fully vaporized.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible from the following descriptions of the embodiments with reference to the accompanying drawings, where:

FIG. 1 is a schematic structural diagram of a cartridge according to an embodiment of the present disclosure;

FIG. 2 is a schematic structural diagram of a cartridge from another perspective according to an embodiment of the present disclosure;

FIG. 3 is an exploded view of a cartridge according to an embodiment of the present disclosure;

FIG. 4 is a schematic structural diagram of a liquid guide body of a cartridge according to an embodiment of the present disclosure;

FIG. 5 is a schematic structural diagram of a liquid guide body of a cartridge according to another embodiment of the present disclosure;

FIG. 6 is a schematic structural diagram of a liquid guide body of a cartridge according to still another embodiment of the present disclosure;

FIG. 7 is a schematic structural diagram of a liquid guide body of a cartridge according to yet another embodiment of the present disclosure;

FIG. 8 is a schematic structural diagram of a liquid guide body of a cartridge according to yet another embodiment of the present disclosure;

FIG. 9 is a schematic diagram of a connection between a second side surface and a heating body of a cartridge according to an embodiment of the present disclosure;

FIG. 10 is a schematic structural diagram of a vaporization core seal member of a cartridge according to an embodiment of the present disclosure;

FIG. 11 is a schematic structural diagram of a vaporization core seal member of a cartridge from another perspective according to an embodiment of the present disclosure; and

FIG. 12 is a cross-sectional view of a vaporization core seal member of a cartridge according to an embodiment of the present disclosure.

### LIST OF REFERENCE NUMERALS

cartridge 100, vaporization core 200,
liquid guide body 1, first side surface 11, second side surface 12, liquid guide portion 13, liquid storage portion 14, step surface 15,
heating body 2, vaporization core seal member 3, liquid flowing opening 31,
housing 4, liquid storage cavity 41, vaporization cavity 42, airway 43, air inlet 44, air outlet 45.

### DETAILED DESCRIPTION

The embodiments of the present disclosure are described in detail below, and the embodiments described with reference to the accompanying drawings are exemplary.

In the description of the present disclosure, it should be understood that, orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” are orientation or position relationship shown based on the accompanying drawings, and are merely used for describing the present disclosure and simplifying the description, rather than indicating or implying that the mentioned apparatus or element should have a particular orientation or be constructed and operated in a particular orientation, and therefore, should not be construed as a limitation to the present disclosure.

In the description of the present disclosure, “a plurality of” means two or more.

A cartridge 100 for an e-cigarette according to an embodiment of the present disclosure is described below with reference to accompanying drawings.

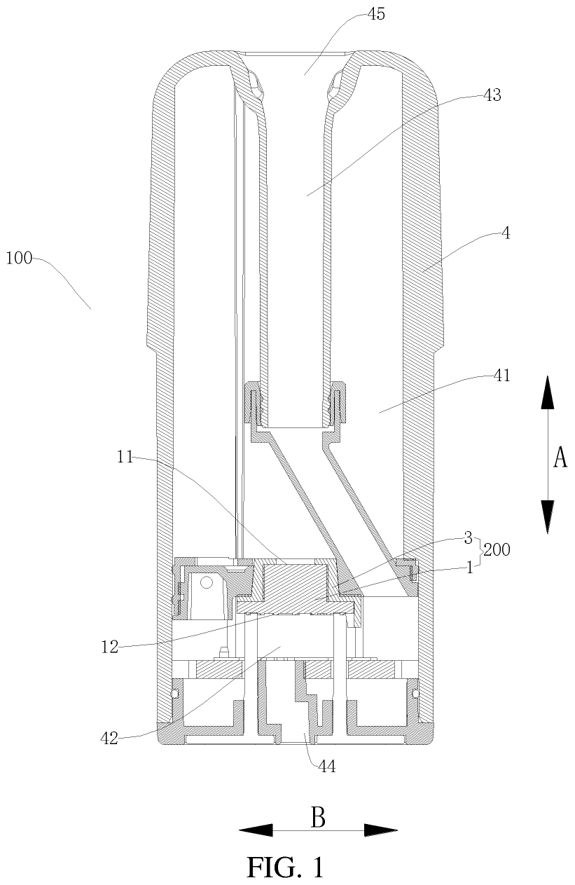

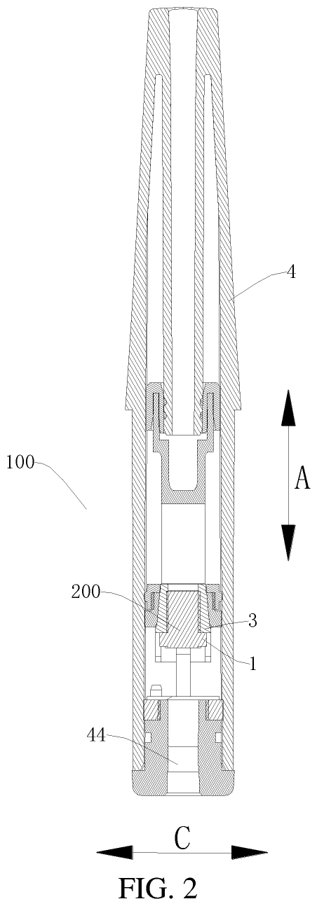

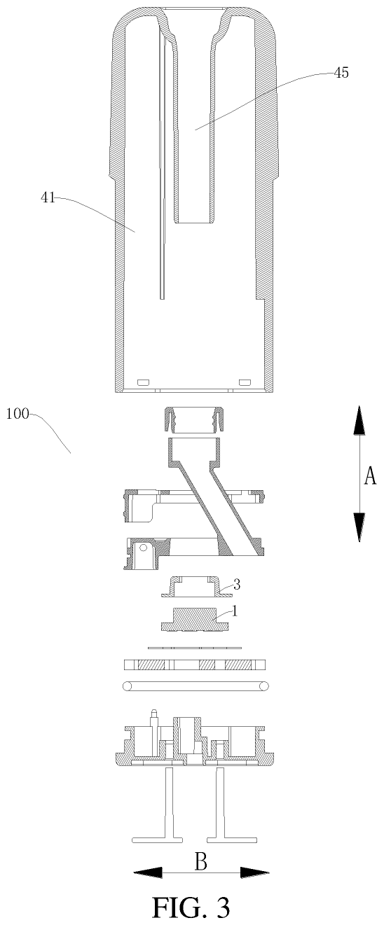

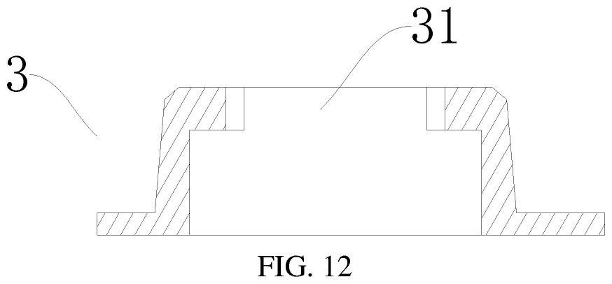

As shown in FIG. 1 to FIG. 12, the cartridge 100 includes a housing 4 and a vaporization core 200 for an e-cigarette according to the following embodiment of the present disclosure.

The housing 4 has a liquid storage cavity 41, an airway 43, and a vaporization cavity 42, and the vaporization cavity 42 is in communication with the airway 43, and the housing 4 has an air inlet 44 in communication with the vaporization cavity 42 and an air outlet in communication with the airway 43. The vaporization core 200 is arranged inside the housing 4.

The vaporization core 200 for the e-cigarette according to this embodiment of the present disclosure is first described with reference to the accompanying drawings.

As shown in FIG. 1 to FIG. 12, the vaporization core 200 for the e-cigarette according to this embodiment of the present disclosure includes a liquid guide body 1 and a heating body 2.

The liquid guide body 1 has a first side surface 11 and a second side surface 12 arranged opposite to each other. It can be understood herein that the first side surface 11 and the second side surface 12 are arranged opposite to each other, and the first side surface 11 and the second side surface 12 are not limited to being necessarily parallel. At least a part of the first side surface 11 forms a liquid absorbing region, and at least a part of the second side surface 12 forms a vaporization region. The liquid guide body 1 includes a liquid guide portion 13. The liquid guide portion 13 is a part of the liquid guide body 1 between the first side surface 11 and a position obtained by translating the first side surface 11 to the second side surface 12 by 1 mm to 4 mm.

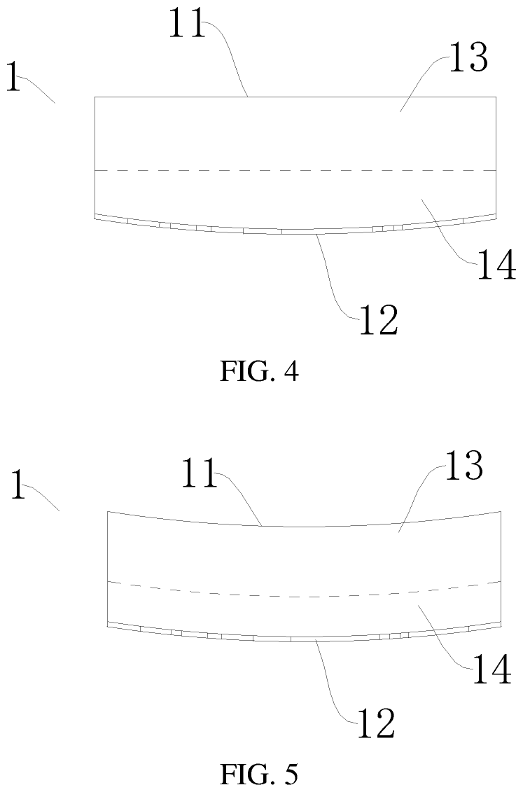

It should be noted that a distance between a boundary surface (shown by dashed lines in FIG. 4, FIG. 5, and FIG. 7) of the liquid guide portion 13 and the first side surface 11 is 1 mm to 4 mm. A part between the first side surface 11 and the boundary surface is defined as the liquid guide portion 13, and a shapes of the boundary surface follows that of the first side surface 11. That is, if the first side surface 11 is a curved surface, the boundary surface is a curved surface (shown in FIG. 4 and FIG. 5); and if the first side surface 11 is a flat surface, the boundary surface is a flat surface (shown in FIG. 7). In some embodiments of the present disclosure, the first side surface 11 and the boundary surface may be set as surfaces in other shapes. In other words, regardless of the shape of the first side surface 11, the liquid guide portion 13 has a volume defined by the translation of the first side surface 11 toward the second side surface 12 by 1 mm to 4 mm.

In addition, in some embodiments of the present disclosure, the second side surface 12 may be constructed as a surface in a different shape, for example, a flat surface shown in FIG. 4, or a curved surface shown in FIG. 5.

A liquid storage amount Q2 of the liquid guide portion 13 is equal to 2.5 mg to 75 mg; and the heating body 2 is arranged at the vaporization region of the second side surface 12.

The liquid absorbing region of the first side surface 11 is in communication with the liquid storage cavity 41, and the liquid absorbing region can absorb the vaporization liquid from the liquid storage cavity 41, so as to facilitate the vaporization of the vaporization liquid in the e-cigarette. The vaporization region of the second side surface 12 is in communication with the vaporization cavity 42.

For example, the calculation method of the liquid storage amount of the liquid guide portion 13 is: the volume of the liquid guide portion 13×the porosity of the liquid guide portion 13×the density of the vaporization liquid, where the vaporization liquid is an e-liquid conventionally used in the field of e-cigarettes. According to the embodiments of the present disclosure, the density of the e-liquid is generally 1.05 kg/m³ to 1.2 kg/m³. In addition, the liquid storage amount of the liquid guide portion 13 may be 3 mg to 70 mg, 8 mg to 60 mg, 10 mg to 50 mg, 12 mg to 40 mg, 14 mg to 30 mg, 15 mg to 20 mg, such as 5 mg, 10 mg, 15 mg, 20 mg, 25 mg, 30 mg, 35 mg, 40 mg, 45 mg, 50 mg, 55 mg, 60 mg, 65 mg, 70 mg, and 75 mg.

The liquid guide portion 13 may be a part of the liquid guide body 1 between the first side surface 11 and a position obtained by translating the first side surface 11 to the second side surface 12 by 1 mm, 1.5 mm, 2 mm, 2.5 mm, 3 mm, 3.5 mm, or 4 mm.

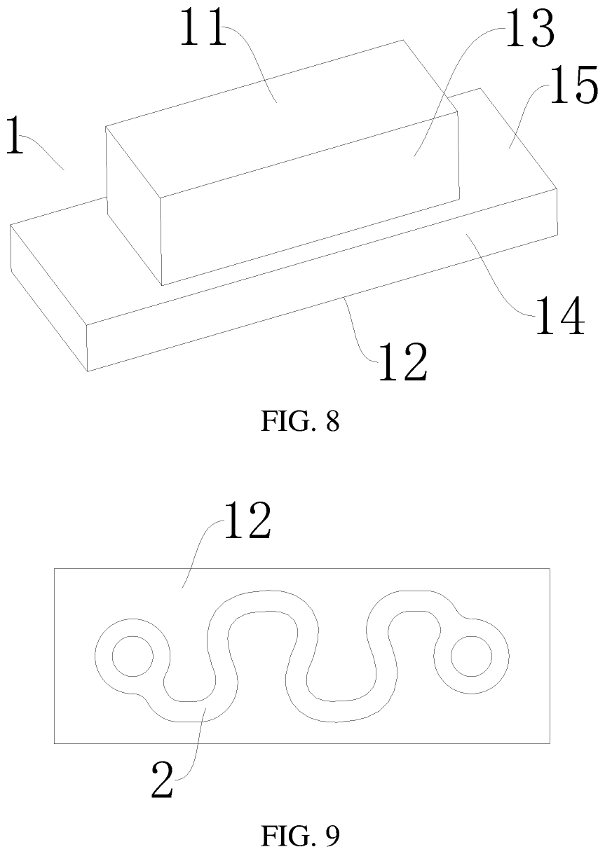

According to the vaporization core in an embodiment of the present disclosure, the liquid guide body 1 is shown in FIG. 8. The calculation method of the volume of the liquid guide portion 13 is: the area of the first side surface 11×the height of the liquid guide portion 13, where the height of the liquid guide portion 13 refers to a dimension of the liquid guide portion in an extending direction from the first side surface 11 to the second side surface 12. In this embodiment, the area of the first side surface 11=length of the first side surface 11×width of the first side surface 11.

In this embodiment, both the liquid guide portion 13 and the liquid storage portion 14 are porous ceramic bodies, and the liquid guide portion 13 and the liquid storage portion 14 have a same porosity, the measurement method of the porosity of the porous ceramic body is a conventional measurement method in the art. For example, the measurement method of the porosity of the porous ceramic body may be based on the test method for the apparent porosity of porous ceramics in GBT1966-1996.

According to the vaporization core 200 for the e-cigarette in this embodiment of the present disclosure, by arranging the heating body 2 at the vaporization region of the second side surface 12, that is, after the vaporization liquid absorbed by the liquid absorbing region penetrates to the surface of the vaporization region, the vaporization liquid is heated by the heating body 2 to form smoke (which includes, but not limited to, aerosol, suspended liquid, low-temperature vapor, and volatile gas), and the smoke enters the vaporization cavity 42. When the user inhales the e-cigarette, the external air enters the vaporization cavity 42 and is mixed with the air in the vaporization cavity 42 to be inhaled by the user.

According to the vaporization core 200 for the e-cigarette in this embodiment of the present disclosure, it has been found that phenomena such as “e-liquid frying” and “burnt core” in the related art is caused by mismatching between the amount of the vaporization liquid required in single vaporization and the amount of the vaporization liquid that is effectively vaporized by the vaporization core.

Based on this, it has been found in a large quantity of experiments and researches that a temperature of a part of the liquid guide body between the first side surface and a position obtained by translating the first side surface to the second side surface by 1 mm to 4 mm cannot reach a vaporization temperature of the vaporization liquid. This part is a non-vaporization region, and this part of non-vaporization region of the liquid guide body 1 is defined as the liquid guide portion 13, and other parts are defined as a liquid storage portion 14. In addition, based on the above, after in-depth research, it has been found that the part between the first side surface 11 and a position obtained by translating the first side surface to the second side surface 12 by 1 mm to 4 mm mainly replenishes the vaporization liquid to the liquid storage portion 14, and the part between the first side surface 11 and a position obtained by translating the first side surface to the second side surface 12 by 1 mm to 4 mm is defined as the liquid guide portion 13.

Further, the relationship between the liquid storage amount of the liquid guide portion 13 and the phenomenon of “e-liquid frying” has been further studied, and it has been found that by controlling the liquid storage amount of the liquid guide portion 13, the liquid storage amount of the liquid guide portion 13 is made to be 2.5 mg to 75 mg, which can reach a balance with an amount of the vaporization liquid vaporized by the vaporization core in one inhalation cycle. Therefore, it is ensured that the vaporization liquid is fully vaporized, and the vaporization amount is stable; and it is also ensured that the e-liquid in the liquid guide portion 13 can be replenished to the liquid storage portion 14 in a timely and appropriate manner. That is, the problems such as “e-liquid frying” or “burnt core” during inhalation of the e-cigarette in the related art that seriously affect the inhalation taste of the e-cigarette can be effectively solved.

In this way, it can be ensured that the vaporization liquid is sufficient to ensure the amount of vapor output, and it can avoid a case that the vaporization liquid is excess and cannot be fully vaporized, to prevent that unvaporized vaporization liquid penetrates into parts other than the vaporization region and gathers, which causes phenomena such as “e-liquid frying” and “burnt core”. Therefore, it is ensured that the demand for inhalation is met, e-liquid leakage is prevented, and the user experience is improved.

Therefore, the vaporization core 200 for the e-cigarette according to this embodiment of the present disclosure can match the single-inhalation vaporization amount, thereby ensuring the amount of vapor output, and ensuring that the vaporization liquid is fully vaporized.

The cartridge 200 for the e-cigarette according to this embodiment of the present disclosure uses the vaporization core 100 for the e-cigarette according to the foregoing embodiment of the present disclosure, which can match the single-inhalation vaporization amount, thereby ensuring the amount of vapor output, and ensuring that the vaporization liquid is fully vaporized.

According to some exemplary embodiments of the present disclosure, as shown in FIG. 4 to FIG. 8, in one inhalation cycle, an inhalation time of the vaporization core 200 is 2.9 seconds to 3.1 seconds, and a total inhalation flow thereof is 54.4 ml to 55.6 ml, where the total inhalation flow is a sum of an air flow and a smoke flow. In this way, it helps to ensure the concentration of the smoke and the total amount of the smoke during each inhalation of the user, which helps to ensure the taste and improve the user's inhalation experience.

In addition, the single-inhalation vaporization amount T1 is equal to 5 mg to 10 mg. In other words, in each inhalation process, the vaporization liquid is consumed by 5 mg to 10 mg. The single-inhalation vaporization amount is more adapted to the vaporization amount required by the user, so that the inhalation demand of the user can be met, and the vaporization amount will not be excessively large to cause waste of the vaporization liquid.

According to some exemplary embodiments of the present disclosure, as shown in FIG. 4 to FIG. 8, quality of the vaporization liquid actually vaporized by the vaporization core 200 in one inhalation cycle is defined as a single-inhalation vaporization amount T1; and a liquid guide amount D1 of the liquid guide portion meets: 0.5T1≤D1≤1.2T1. In other words, the liquid guide amount of the liquid guide portion 13 is 0.5 times to 1.2 times of the single-inhalation vaporization amount. Further, the liquid guide amount D1 of the liquid guide portion meets: 0.8T1≤D1≤1.0T1. For example, the liquid guide amount of the liquid guide portion 13 is 0.5 times, 0.6 times, 0.7 times, 0.8 times, 0.9 times, 0.10 times, 1.1 times, or 1.2 times of the single-inhalation vaporization amount.

After each inhalation of the user, the vaporization liquid in the liquid guide portion 13 will be replenished to the liquid storage portion 14, and the liquid guide amount of the liquid guide portion 13 will be 0.5 times to 1.2 times of the single-inhalation vaporization amount. The vaporization liquid in the liquid guide portion 13 can be replenished into the liquid storage portion 14 in time to prepare for next inhalation of the user, and the liquid guide portion 13 can be prevented from replenishing excess vaporization liquid into the liquid storage portion 14.

For example, the calculation method of the liquid guide amount of the liquid guide portion 13 is: a liquid guide speed of the liquid guide portion 13×an area of the liquid absorbing region×the inhalation time in one inhalation cycle (for example, 3 seconds)×the density of the vaporization liquid, where the vaporization liquid is an e-liquid conventionally used in the field of e-cigarettes. According to the embodiments of the present disclosure, the density of the e-liquid usually is 1.05 kg/m³ to 1.2 kg/m³.

An example is used to illustrate the test method of the single-inhalation vaporization amount. The single-inhalation vaporization amount is usually measured according to GB41700-2022, where the inhalation duration specified by “single-inhalation” is (3.0±0.1) second, and the total inhalation flow is (55±0.6) ml. A glass fiber filter is used to collect e-cigarette emissions, and the glass fiber filter before and after inhalation is separately weighed on an analytical balance with a sensitivity ≤0.1 mg. The quality difference is the single-inhalation vaporization amount, and a unit thereof is mg.

An example is used to illustrate the test method of the liquid guide speed of the liquid guide portion 13. A dry liquid guide portion 13 to be tested with a height of h is fixed on a fixture to keep horizontal, and each generatrix of the liquid guide portion 13 is ensured to be vertically upward. Two to three drops of e-liquid are quickly dripped at the center position above the liquid guide portion 13, and a time t from a moment at which the e-liquid is just in contact with an upper region of the liquid guide portion 13 to a moment at which the e-liquid just permeates to a lower part the liquid guide portion 13 is recorded, where t/h is the liquid guide speed of the measured liquid guide body, and a unit thereof is mm/s.

According to this embodiment of the present disclosure, as shown in FIG. 8, the area of the liquid absorbing region=an area of the first side surface 11=length of the first side surface 11×width of the first side surface 11.

In this way, the liquid guide amount of the liquid guide portion 13 can meet the replenishment demand for the liquid storage amount of the liquid storage portion 14. By controlling the liquid guide amount of the liquid guide portion 13, the liquid storage amount of the liquid storage portion 14 can match the single-inhalation vaporization amount, which can not only ensure that the vaporization liquid is fully vaporized, and the vaporization amount is stable, but also ensure that the e-liquid in the liquid guide portion 13 can be replenished to the liquid storage portion 14 in a timely and appropriate manner. That is, the problems such as “e-liquid frying” or “burnt core” during inhalation of the e-cigarette in the related art that seriously affect the inhalation taste of the e-cigarette can be effectively solved.

According to some exemplary embodiments of the present disclosure, as shown in FIG. 4 to FIG. 8, the liquid guide amount of the liquid guide portion 13 is 2.5 mg to 12 mg. For example, the liquid guide amount of the liquid guide portion 13 is 2.5 mg, 3 mg, 3.5 mg, 4 mg, 4.5 mg, 5 mg, 5.5 mg, 6 mg, 6.5 mg, 7 mg, 7.5 mg, 8 mg, 8.5 mg, 9 mg, 9.5 mg, 10 mg, 10.5 mg, 11 mg, 11.5 mg, or 12 mg.

The liquid guide portion 13 can lengthen a path of the liquid guide body 1 for absorption and penetration of the vaporization liquid, and increase the amount of vaporization liquid used for vaporization. The liquid guide portion 13 may be a part of the liquid guide body 1 between the first side surface 11 and a position obtained by translating the second side surface 12 to the first side surface 11 by 0.5 mm, 0.6 mm, 0.7 mm, 0.8 mm, 0.9 mm, 1.0 mm, 1.1 mm, 1.2 mm, 1.3 mm, 1.4 mm, or 1.5 mm.

For example, the calculation method of the liquid guide amount of the liquid guide portion 13 is: the liquid guide speed of the liquid guide portion 13×the area of the liquid absorbing region×the inhalation time in one inhalation cycle (for example, 3 S)×the density of the vaporization liquid, where the density of the vaporization liquid is 1.05 kg/m³ to 1.2 kg/m³.

In this way, the liquid guide amount of the liquid guide portion 13 can meet the replenishment demand for the liquid storage amount of the liquid storage portion 14. By controlling the liquid guide amount of the liquid guide portion 13, the liquid storage amount of the liquid storage portion 14 can match the single-inhalation vaporization amount, which can not only ensure that the vaporization liquid is fully vaporized, and the vaporization amount is stable, but also ensure that the e-liquid in the liquid guide portion 13 can be replenished to the liquid storage portion 14 in a timely and appropriate manner. That is, the problems such as “e-liquid frying” or “burnt core” during inhalation of the e-cigarette in the related art that seriously affect the inhalation taste of the e-cigarette can be effectively solved.

In addition, a liquid guide amount D1 of the liquid guide portion 13 and the liquid storage amount Q2 of the liquid guide portion 13 meet: D1≤Q2≤3D1. In this way, a ratio of the liquid guide amount of the liquid guide portion 13 to the liquid storage amount thereof can meet the replenishment demand for the liquid storage amount of the liquid storage portion 14. By controlling the ratio of the liquid guide amount of the liquid guide portion 13 to the liquid storage amount thereof, the liquid storage amount of the liquid storage portion 14 can match the single-inhalation vaporization amount, which can not only ensure that the vaporization liquid is fully vaporized, and the vaporization amount is stable, but also ensure that the e-liquid in the liquid guide portion 13 can be replenished to the liquid storage portion 14 in a timely and appropriate manner. That is, the problems such as “e-liquid frying” or “burnt core” during inhalation of the e-cigarette in the related art that seriously affect the inhalation taste of the e-cigarette can be effectively solved.

According to some exemplary embodiments of the present disclosure, as shown in FIG. 4 to FIG. 8, the liquid guide body 1 further includes a liquid storage portion 14, and the liquid storage portion 14 is a part of the liquid guide body 1 between the second side surface 12 and a position obtained by translating the first side surface 11 to the second side surface 12 by 1 mm to 4 mm. The liquid guide portion 13 and the liquid storage portion 14 are separate pieces or an integral piece.

By dividing the liquid guide body 1 into a liquid guide portion 13 and a liquid storage portion 14, the liquid guide portion 13 and the liquid storage portion 14 can be integrally formed to reduce processing difficulty. In some embodiments of the present disclosure, the liquid guide portion 13 and the liquid storage portion 14 are arranged separately, and the structures of the liquid guide portion 13 and the liquid storage portion 14 are more diverse, which improves the applicability of the liquid guide body 1 and takes both costs and vaporization efficiency into account.

The liquid storage portion 14 may be a part of the liquid guide body 1 between the second side surface 12 and a position obtained by translating the first side surface 11 to the second side surface 12 by 1 mm, 1.5 mm, 2 mm, 2.5 mm, 3 mm, 3.5 mm, or 4 mm.

According to some exemplary embodiments of the present disclosure, as shown in FIG. 4 to FIG. 8, the liquid guide body 1 further includes a liquid storage portion 14, and the liquid storage portion 14 is a part of the liquid guide body 1 between the second side surface 12 and a position obtained by translating the first side surface 11 to the second side surface 12 by 1 mm to 4 mm Materials of the liquid guide portion 13 and the liquid storage portion 14 are the same or different.

The liquid storage portion 14 may be a part of the liquid guide body 1 between the second side surface 12 and a position obtained by translating the first side surface 11 to the second side surface 12 by 1 mm, 1.5 mm, 2 mm, 2.5 mm, 3 mm, 3.5 mm, or 4 mm.

By dividing the liquid guide body 1 into a liquid guide portion 13 and a liquid storage portion 14, the liquid guide portion 13 and the liquid storage portion 14 may be made of different materials. The liquid guide portion 13 may be made of a material with high liquid absorption capacity, and the liquid storage portion 14 may be made of a high-temperature-resistant material.

In some embodiments of the present disclosure, the liquid guide portion 13 and the liquid storage portion 14 are made of a same material, but the parameters such as cross-sectional areas, volumes, heights, or shapes of the liquid guide portion 13 and the liquid storage portion 14 are different, thereby improving the applicability of the liquid guide body 1, and taking both costs and vaporization efficiency into account.

In some embodiments of the present disclosure, in order to ensure the structural strength and the high-temperature-resistant performance of the liquid storage portion 14, the liquid storage portion 14 may be set as ceramic. For example, the liquid storage portion 14 is formed by one or more porous ceramic members. In order to improve the vaporization liquid absorption and penetration efficiency of the liquid guide portion 13, the liquid guide portion 13 may be ceramic. For example, the liquid guide portion 13 is formed by one or more porous ceramic members. The liquid guide portion 13 and the liquid storage portion 14 may be an integrally formed whole porous ceramic body.

In some embodiments of the present disclosure, the liquid guide portion 13 and the liquid storage portion 14 may be e-liquid absorbing cotton. For example, the liquid storage portion 14 is formed by one or more pieces of e-liquid absorbing cotton, and the liquid guide portion 13 is formed by one or more pieces of e-liquid absorbing cotton. The liquid guide portion 13 and the liquid storage portion 14 may be integrally formed, so that the costs are low and the mounting space is small.

In some embodiments of the present disclosure, one of the liquid guide portion 13 and the liquid storage portion 14 is ceramic and the other is e-liquid absorbing cotton, and the e-liquid absorbing cotton may be bonded to the ceramic. For example, the liquid guide portion 13 is jointly formed by one or more porous ceramic members and one or more pieces of e-liquid absorbing cotton, and the liquid guide portion 14 is jointly formed by one or more porous ceramic members and one or more pieces of e-liquid absorbing cotton. In this way, the costs, mounting space, and vaporization liquid absorption and penetration efficiency are taken into consideration.

In some embodiments of the present disclosure, the heating body 2 is a heating circuit printed on the vaporization region of the second side surface 12, so that the heating body 2 is formed by printing and forms an integral structure with the liquid guide body 1. The strength of the connection between the heating body 2 and the liquid guide body 1 is high, and the two bodies can be assembled and disassembled synchronously, so that the production efficiency is high. In addition, the heating body 2 and the liquid guide body 1 are more closely fitted, and the reliability for vaporization of the vaporization liquid on the second side surface 12 is higher.

In some other embodiments of the present disclosure, the heating body 2 is a heating metal mesh arranged at the vaporization region of the second side surface 13. In this way, the heating body 2 and the liquid guide body 1 may be arranged separately, which facilitates the replacement of the heating body 2 or the liquid guide body 1, thereby improving the recycling rate, and reducing damage.

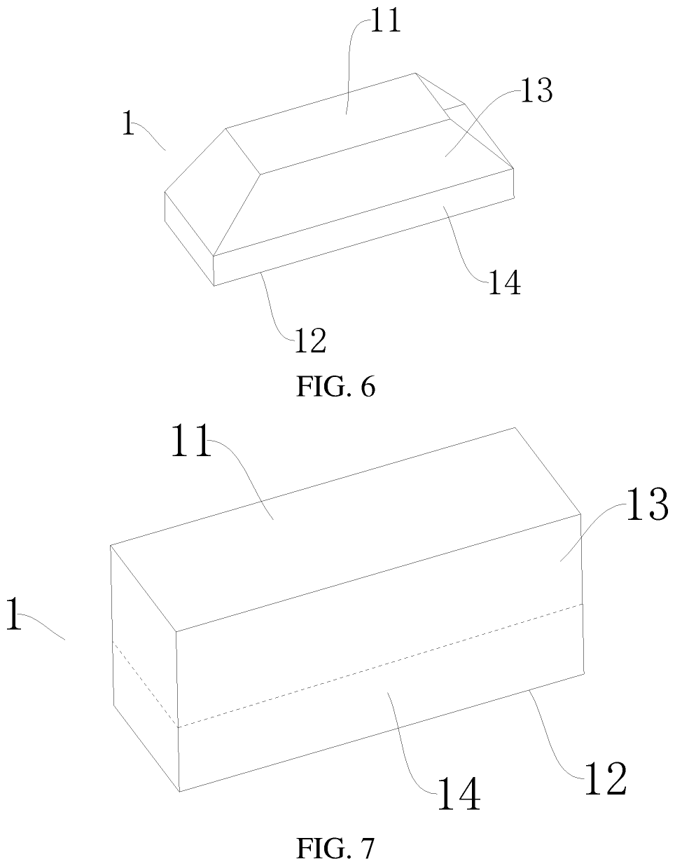

According to some exemplary embodiments of the present disclosure, as shown in FIG. 6 and FIG. 8, the liquid guide body 1 further includes a liquid storage portion 14, and the liquid storage portion 14 is a part of the liquid guide body 1 between the second side surface 12 and a position obtained by translating the first side surface 11 to the second side surface 12 by 1 mm to 4 mm. An orthographic projection area of the liquid guide portion 13 is less than or equal to an orthographic projection area of the liquid storage portion 14 within a plane perpendicular to a direction from the first side surface 11 to the second side surface 12.

By dividing the liquid guide body 1 into a liquid guide portion 13 and a liquid storage portion 14, the liquid guide portion 13 and the liquid storage portion 14 may be made of different materials. The liquid guide portion 13 may be made of a material with high liquid absorption capacity, and the liquid storage portion 14 may be made of a high-temperature-resistant material.

The liquid storage portion 14 may be a part of the liquid guide body 1 between the second side surface 12 and a position obtained by translating the first side surface 11 to the second side surface 12 by 1 mm, 1.5 mm, 2 mm, 2.5 mm, 3 mm, 3.5 mm, or 4 mm.

Because the orthographic projection area of the liquid guide portion 13 is less than the orthographic projection area of the liquid storage portion 14 in the plane perpendicular to the direction from the first side surface 11 to the second side surface 12, a step surface 15 located in the circumferential direction of the liquid guide portion 13 may be formed between the liquid guide portion 13 and the liquid storage portion 14, which can not only improve the liquid absorption efficiency of the liquid guide portion 13, but also ensure the effect and stability of vaporizing the vaporization liquid on the liquid storage portion 14 by the heating body 2.

According to some exemplary embodiments of the present disclosure, as shown in FIG. 6, the liquid storage portion 14 is constructed as a cuboid shape, and the liquid guide portion 13 is constructed as a cuboid shape, a frustum of trapezoidal prism shape, or a frustum of triangular prism shape. In some embodiments of the present disclosure, the arrangement of the liquid guide portion 13 is more diverse, and can be applied to different usage scenarios. The surface of the liquid guide portion 13 connected to the liquid storage portion 14 is a flat surface, which facilitates the connection between the liquid storage portion 14 and the liquid guide portion 13.

According to some exemplary embodiments of the present disclosure, as shown in FIG. 6 and FIG. 8, an area of the liquid absorbing region is less than or equal to an area of the vaporization region. In other words, the vaporization liquid absorbed by the liquid absorbing region can fully penetrate to at least a part of the surface of the vaporization region, which avoids excessively rapid penetration of the vaporization liquid absorbed by the liquid absorbing region and gathering in a low temperature region other than the vaporization region that causes “e-liquid frying”, and avoids e-liquid leakage, thereby improving the utilization efficiency of the vaporization liquid absorbed by the liquid absorbing region, ensuring the vaporization purity of the smoke in the vaporization cavity 42, and improving the user's inhalation experience.

In some embodiments of the present disclosure, the area of the liquid absorbing region is 9% to 95% of the area of the vaporization region. For example, the area of the liquid absorbing region may be 9%, 20%, 30%, 40%, or 50% of the area of the vaporization region, to ensure the utilization efficiency of the vaporization liquid absorbed by the liquid absorbing region. Considering the vaporization amount requirement of the vaporization region, the area of the liquid absorbing region may be set to be close to the area of the vaporization region. For example, the area of the liquid absorbing region may be 60%, 70%, 80%, 90%, or 95% of the area of the vaporization region.

According to some exemplary embodiments of the present disclosure, as shown in FIG. 4 to FIG. 8, the first side surface 11 is constructed as a flat surface, a polyline curved surface, an arc curved surface, or a spherical surface. When the first side surface 11 is a flat surface, the shape of the first side surface 11 is more regular, which facilitates processing and manufacturing. When the first side surface 11 is a polyline curved surface, an arc curved surface, or a spherical surface, the liquid absorbing area of the liquid absorbing region on the liquid storage portion 14 can be increased, and the liquid absorption efficiency can be improved.

In addition, the second side surface 12 is constructed as a flat surface, a polyline curved surface, an arc curved surface, or a spherical surface. When the second side surface 12 is a flat surface, the shape of the second side surface 12 is more regular, which facilitates processing and manufacturing. When the second side surface 12 is a polyline curved surface, an arc curved surface, or a spherical surface, the heating area of the vaporization region on the liquid storage portion 14 can be increased, and the vaporization efficiency can be improved, so that the vaporization volume of the vaporization liquid at the vaporization region can reach 95% to 98% of the volume of the vaporization liquid on the second side surface 12, thereby effectively avoiding the generation of vaporized condensate.

FIG. 4 and FIG. 5 are schematic diagrams of a two-dimensional arc curved surface of the second side surface 12.

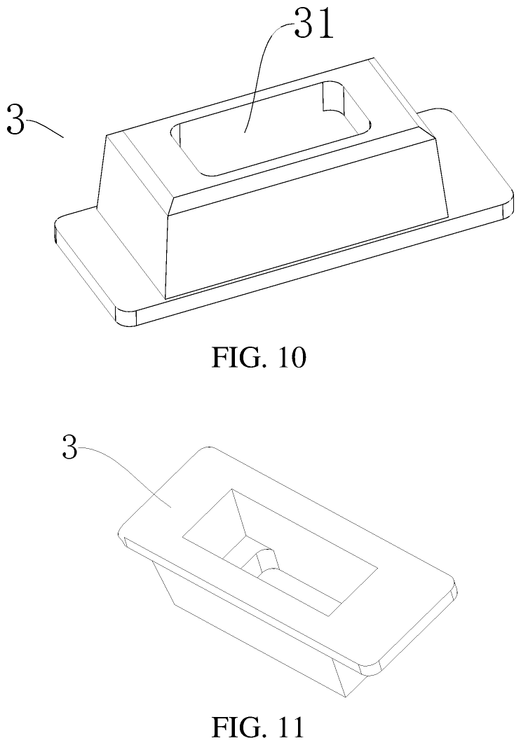

According to some exemplary embodiments of the present disclosure, as shown in FIG. 10 to FIG. 12, the vaporization core 200 for the e-cigarette further includes a vaporization core seal member 3. The vaporization core seal member 3 is sleeved on the liquid guide body 1. The vaporization core seal member 3 has a liquid flowing opening 31, and at least a part of the first side surface 11 is exposed from the liquid flowing opening 31 to form the liquid absorbing region.

In this way, on the one hand, the vaporization core seal member 3 can seal a circumferential gap of the liquid guide body 1, thereby preventing the vaporization liquid in the liquid storage cavity 41 from directly leaking into the vaporization cavity 42 through the circumferential gap of the liquid guide body 1 without passing through the liquid guide body 1, which ensures the vaporization rate of the vaporization liquid, thereby ensuring the utilization of the vaporization liquid. On the other hand, the arrangement of the liquid flowing opening 31 can make the vaporization liquid in the liquid storage cavity 41 be in contact with the liquid guide body 1, so that the vaporization liquid flows to the liquid absorbing region through the liquid flowing opening 31.

An e-cigarette according to an embodiment of the present disclosure is described below with reference to the accompanying drawings. The e-cigarette includes the cartridge 100 according to the foregoing embodiment of the present disclosure and a cigarette rod.

The e-cigarette according to this embodiment of the present disclosure uses the cartridge 100 according to the foregoing embodiment of the present disclosure, which can match the single-inhalation vaporization amount, thereby ensuring the amount of vapor output, and ensuring that the vaporization liquid is fully vaporized.

Other configurations and operations of the vaporization core 200 for the e-cigarette, the cartridge 100 for the e-cigarette, and the e-cigarette according to the embodiments of the present disclosure are known to those of ordinary skill in the art, and will not be described in detail herein.

In description of this specification, description of reference terms such as “an embodiment,” “some embodiments,” “an exemplary embodiment,” “an example,” “a specific example,” or “some examples” mean that specific characteristics, structures, materials, or features described with reference to the embodiment or example are included in at least one embodiment or example of the present disclosure. In this specification, schematic descriptions of the foregoing terms do not necessarily refer to the same embodiment or example.

Although the embodiments of the present disclosure have been shown and described, a person of ordinary skill in the art can understand that various changes, modifications, replacements, and variations may be made to the embodiments without departing from the principles and spirit of the present disclosure, and the scope of the present disclosure is as defined by the appended claims and their equivalents.

What is claimed is:

1. A vaporization core for an e-cigarette, comprising:
a liquid guide body having a first side surface and a second side surface arranged opposite to each other, at least a part of the first side surface forming a liquid absorbing region, at least a part of the second side surface forming a vaporization region, the liquid guide body comprising a liquid guide portion, the liquid guide portion being a part of the liquid guide body between the first side surface and a position obtained by translating the first side surface to the second side surface by 1 mm to 4 mm, a liquid storage amount Q2 of the liquid guide portion being equal to 2.5 mg to 75 mg; and
a heating body arranged at the vaporization region of the second side surface.

2. The vaporization core for the e-cigarette according to claim 1, wherein the liquid storage amount Q2 of the liquid guide portion satisfies: Q2=a volume of the liquid guide portion×porosity of the liquid guide portion×a density of a vaporization liquid.

3. The vaporization core for the e-cigarette according to claim 1, wherein quality of the vaporization liquid actually vaporized by the vaporization core in one inhalation cycle is defined as a single-inhalation vaporization amount T1; and
a liquid guide amount D1 of the liquid guide portion meets: 0.5T1≤D1≤1.2T1.

4. The vaporization core for the e-cigarette according to claim 3, wherein the liquid guide amount D1 of the liquid guide portion meets: 0.8T1≤D1≤1.0T1.

5. The vaporization core for the e-cigarette according to claim 3, wherein the liquid guide amount D1 of the liquid guide portion ranges from 2.5 mg to 12 mg.

6. The vaporization core for the e-cigarette according to claim 3, wherein in one inhalation cycle, an inhalation time of the vaporization core is 2.9 seconds to 3.1 seconds, and a total inhalation flow of the vaporization core is 54.4 ml to 55.6 ml.

7. The vaporization core for the e-cigarette according to claim 3, wherein the single-inhalation vaporization amount T1 is equal to 5 mg to 10 mg.

8. The vaporization core for the e-cigarette according to claim 1, wherein a liquid guide amount D1 of the liquid guide portion and the liquid storage amount Q2 of the liquid guide portion meet: D1≤Q2≤3D1.

9. The vaporization core for the e-cigarette according to claim 3, wherein the liquid guide amount D1 of the liquid guide portion satisfies: D1=an area of the liquid absorbing region×a liquid guide rate of the liquid guide portion×an inhalation time in one inhalation cycle×a density of the vaporization liquid.

10. The vaporization core for the e-cigarette according to claim 1, wherein the liquid guide body further comprises a liquid storage portion, and the liquid storage portion is a part of the liquid guide body between the second side surface and a position obtained by translating the first side surface to the second side surface by 1 mm to 4 mm; and
the liquid guide portion and the liquid storage portion are separate pieces or an integral piece.

11. The vaporization core for the e-cigarette according to claim 1, wherein the liquid guide body further comprises a liquid storage portion, and the liquid storage portion is a part of the liquid guide body between the second side surface and a position obtained by translating the first side surface to the second side surface by 1 mm to 4 mm; and
materials of the liquid guide portion and the liquid storage portion are the same or different.

12. The vaporization core for the e-cigarette according to claim 11, wherein the liquid guide portion is ceramic or e-liquid absorbing cotton; and
the liquid storage portion is ceramic or e-liquid absorbing cotton.

13. The vaporization core for the e-cigarette according to claim 1, wherein the liquid guide portion is formed by one or more porous ceramic members;
the liquid guide portion is formed by one or more pieces of e-liquid absorbing cotton; or
the liquid guide portion is jointly formed by one or more porous ceramic members and one or more pieces of e-liquid absorbing cotton.

14. The vaporization core for the e-cigarette according to claim 11, wherein the liquid storage portion is formed by one or more porous ceramic members;
the liquid storage portion is formed by one or more pieces of e-liquid absorbing cotton; or
the liquid storage portion is jointly formed by one or more porous ceramic members and one or more pieces of e-liquid absorbing cotton.

15. The vaporization core for the e-cigarette according to claim 1, wherein the heating body is a heating circuit printed on the vaporization region of the second side surface; or
the heating body is a heating metal mesh arranged at the vaporization region of the second side surface.

16. The vaporization core for the e-cigarette according to claim 1, wherein the liquid guide body further comprises a liquid storage portion, and the liquid storage portion is a part of the liquid guide body between the second side surface and a position obtained by translating the first side surface to the second side surface by 1 mm to 4 mm; and an orthographic projection area of the liquid guide portion is less than or equal to an orthographic projection area of the liquid storage portion within a plane perpendicular to a direction from the first side surface to the second side surface,
wherein the liquid storage portion is constructed as a cuboid shape, and the liquid guide portion is constructed as a cuboid shape, a frustum of trapezoidal prism shape, or a frustum of triangular prism shape.

17. The vaporization core for the e-cigarette according to claim 1, wherein an area of the liquid absorbing region is less than or equal to an area of the vaporization region.

18. The vaporization core for the e-cigarette according to claim 1, further comprising:
a vaporization core seal member, the vaporization core seal member being sleeved on the liquid guide body, the vaporization core seal member having a liquid flowing opening, and the at least part of the first side surface being exposed from the liquid flowing opening to form the liquid absorbing region.

19. A cartridge for an e-cigarette, comprising:
a housing having a liquid storage cavity, an airway, and a vaporization cavity, the vaporization cavity being in communication with the airway, and the housing having an air inlet in communication with the vaporization cavity and an air outlet in communication with the airway; and
the vaporization core for the e-cigarette according to claim 1, the vaporization core being arranged inside the housing, the liquid absorbing region of the first side surface being in communication with the liquid storage cavity, and the vaporization region of the second side surface being in communication with the vaporization cavity.

20. An e-cigarette, comprising:
the cartridge according to claim 19; and
a cigarette rod having an electrical component arranged therein, the electrical component being electrically connected to the heating body, and the electrical component being configured to supply power to the heating body.
